(19) United States
(12) Patent Application Publication
(10) Pub. No.: US 2013/0129890 A1
(43) Pub. Date: May 23, 2013

(54) FOOD PANS WITH THERMAL CONVEYANCE DEPRESSIONS

(71) Applicant: Monte William Cox, Kansas City, MO (US)

(72) Inventor: Monte William Cox, Kansas City, MO (US)

(21) Appl. No.: 13/479,257

(22) Filed: May 23, 2012

Related U.S. Application Data
(60) Provisional application No. 61/519,601, filed on May 24, 2011.
(60) Provisional application No. 61/536,551, filed on Sep. 19, 2011.

(51) Int. Cl. A47J 37/01

(52) U.S. Cl. CPC A47J 37/01
USPC 426/496; 99/447; 426/523

(57) ABSTRACT

Various types of food preparation pans such as but not limited to food preparation pans used for baking, steaming, chilling, freezing and molding various foods and food combinations intended for consumption are disclosed. The pan includes a plurality of thermal conveyance depressions protruding in a vertically oriented disposition relative to a horizontal inner pan bottom surface; and upwardly projected depressions in an outer pan bottom surface of the thermal conveyance depressions to form hollow depressions spaced in between by bridging portions.

The present application claims priority to Provisional Application Ser. Nos. 61/519,601, filed May 24, 2011 and 61/536,551, filed Sep. 19, 2011, the contents of which are incorporated by reference.

### BACKGROUND OF THE INVENTION

The present invention relates generally to food preparation pans.

### DESCRIPTION OF RELATED ART

Food pans are commonly used in baking applications where food ingredients are combined to produce food items such cakes, cupcakes and so on. This is accomplished with traditional baking (or cooking as the case may be) pans or sheets, typically in round, square and rectangular configurations. In a mass production facility, the pans may take on a configuration and shape that allows multiple food items to be baked, cooked, roasted, and so on. These traditional pans are commonly known and are typically made of aluminum, steel, glass, foil, and at times high temperature plastics.

Baking the ingredients in a traditional pan to produce a food item requires the thermal transfer of heat from the surrounding ambient environment into the ingredients in order to cook them sufficiently for human consumption. Likewise, food items that have been produced may are at times are reheated for consumption at a later date. In either case the ingredients or food item being heated in a traditional pan is brought to a proper temperature or doneness that is conducive for human consumption. Whether it is a professional chef at a restaurant, a manufacturer of food products or a person baking in the comfort and convenience of their dwelling, heating ingredients and food items to a proper temperature that is conducive for human consumption is critical in safeguarding the health and well-being of individuals and families.

Food poisoning due to undercooked food leads to a myriad of issues such as sickness. Sicknesses from undercooked food can easily lead to a loss of productivity not only on a personal level for an individual but can also lead to a loss of productivity at a professional level. An individual who must remain home for an extended period of time not only loses the ability to act in a manner suiting them but, the employer who employs this individual also loses productivity that may be vital to the company and to the economy. Death can also occur due when food is undercooked.

Besides the obvious and permanent loss of productivity from the individual, additional costs of funeral arrangements, coffins, life insurance policies and the loss of productivity from all individuals attending the funeral of the deceased are also incurred. If the undercooked food was provided by a restaurant, food manufacturer or other such venue, that company's name and reputation will be negatively affected. In addition, the liability incurred by such an entity and event involving food poisoning may cause significant damage to it financial solvency. The complete and total shut down of a restaurant or any such food preparation facility results not only in a massive loss of jobs but also reduces the taxable income a local municipality could have gained by having the business and people working in it gainfully employed.

Various types of traditional food pans are also used in a wide variety of applications designed to cool and refrigerate the foods by the transferring thermal temperatures away from food items contained in the pan. This is usually accomplished by surrounding the pan and its contents in an ambient temperature that is less than the temperature of the food items. This too may be a critical step in the preparation of other types of foods that can and will be consumed, for example an improperly frozen casserole in a standard pan may not thoroughly freeze. These unfrozen portions could encourage bacterial growth and render the food unfit for human consumption. Baked, cooked, and at times uncooked foods that are massed produced in production facilities typically require refrigeration and freezing after the manufacturing process is complete. Thus improper or insufficient cooling may create a severe liability due to inadequate cooling of freezing.

These manufacturers also recommend the same cooling requirement be carried through warehousing, during shipment, and in the grocery store display and finally, in the consumer's, commercial or residential, refrigeration or freezing or refrigeration devices. Proper refrigeration and or freezing aids greatly in reducing the potential bacteria growth within the food and helps to ensure that safe products are put onto the market. Food poisoning can just as easily occur with under cooked food items and improperly refrigerated or frozen goods. In addition, the substantial reduction of shelf life may occur, which may create significant financial loss. Food manufacturers, chef's, restaurant owners, and residential customers should prepare food items within the optimal temperatures and settings that ensure safe consumption and maintain shelf life.

Food items should also be prepared as quickly as possible and with the minimum amount of energy necessary to achieve a proper and optimal temperature for safe for consumption and maximum shelf life. To help accomplish this objective, a myriad number of materials are have been used in pan construction such as copper bottoms, copper plating, specialty steels, glass and so on. Likewise various forms of systems have been employed, such as convection ovens, microwave, preheating pans and so on. Even with the use of various types of pans, heating an oven beyond what is necessary is not only wasteful of natural resources but, also increases the likelihood that food items will burn due to the high heat. Burned or destroyed foods must be disposed of and the whole process of food preparation for that particular food item must be restarted. The direct result is an increase in energy consumption, wasted food, lost productivity and the additional cost of preparing the food items again. Energy is also lost while rapidly freezing or chilling food item(s) in an expeditious manner. Both of these methods result in duplicated efforts, energy loss and increased costs to the manufacturer, restaurant owner and to residential customers. Therefore, it is desirable to provide high quality food in a minimum amount of time and with a minimum amount of energy consumption. To reduce cooking, refrigeration or freezing time frames within the food manufacturing, restaurant, commercial bakeries or residential spheres requires a pan design that promotes the transfer heat either into the food item(s) or out of the food item(s).

The more rapidly that heat can be added or removed to food item(s) in the pan, the less time is required to bake, refrigerate, or freeze the item(s) within the pan. With the increased rapidity of heat transfer both in and out of food item(s), a sizeable reduction in the required amount of energy necessary to heat, refrigerate and freeze the food item(s) is also achieved. At times manufacturers, cooks, chef's or any other such person or entity who is preparing food intended for consumption, will rush through the proper process of food preparation in an effort to keep up with production or consumer demands. Heating an oven far above what is required to cook food items in traditional pans exponentially wastes natural resources in the form of energy. Similarly, rapid freezing of foods may require an excess of natural resources in the form of energy consumption.

The use of certain prior art products such as US Patent 2010/0239729 Multi-Edge-Baking-Pan may help to convey thermal stimulation into and out of food item(s) but may be too impractical for widespread use and acceptance to a wide variety of food and food items. The Multi-Edge-Baking-Pan is not easily used for food items such as casseroles, cakes, ice creams, lasagnas or other similar food items. This particular design could also introduce too high a volume of thermal conductivity causing food to burn unnecessarily. Obviously it is impractical to increase the amount of time necessary to place or construct food items into a pan with such confining sections as to inhibit the smooth and quick layering of the food items efficiently, as well as increase the risk of burning and wasting food.

Prior art such as U.S. Pat. No. 4,676,151 introduces a minute amount of thermal conveyance properties into the pan design and the problem is that too little thermal conveyance is achieved through this design to significantly impact cooking, chilling or freezing times, and reduce energy consumption regardless of the type of pan falling under the '151 patent. It is also impractical to assume that a pan design made specifically for cooking a pizza will thermally transpose the appropriate amount of thermal energy into or out of food items that are significantly thicker than a pizza, such as a 6″ tall cake, or even a 3″ tall sheet cake.

Prior art such as U.S. Pat. No. 6,463,844 induces the transference of heat into food items, specifically breads and dough's, through a means of tiny circular perforations along the bottom lining of the pan. While the transference of heat and steam is effective through these tiny holes, the pan in all of its configurations is relegate to the proofing and baking of breads. The tiny circular holes could not adequately contain flowable substances to be baked, chilled or frozen that contain significant amounts of liquid such as certain casseroles, ice creams or gelatins. While the heat transference is high with this particular type of pan, it does not have a wide range of uses or applications and is limited in its functional scope.

It is understandable that all of these traditional pans, systems, and methods are inadequate at maximizing baking and cooking conditions, all the while, improving heat transference. All of these methods are marginal at best at lowering energy usage, reducing cooking times, and thus lowering costs and improving productivity. A pan that promotes the conveyance of heat or cool that overcomes these problems associated with prior art would be useful in these trades and others.

### BRIEF SUMMARY OF THE INVENTION

Various types of food preparation pans such as but not limited to food preparation pans used for baking, steaming, chilling, freezing and molding various foods and food combinations intended for consumption are disclosed. In one aspect, a pan includes thermal conveyance depressions protruding in a vertically oriented disposition relative to a typically horizontal inner pan bottom surface, wherein the thermal conveyance depressions are upwardly projected depressions in outer pan bottom surface to form hollow depressions spaced in between by bridging portions.

The pan with thermal conveyance depressions in one embodiment of the present invention overcomes the problems associated with prior art. The pan of the present invention improves the transfer of heating or cooling properties, reduces cooking and heating times, and provides more consistently cooked foods throughout the pan. The risk of wasting food, sickness due to contaminated foods, loss of shelf, and lost productivity are substantially reduced with the present invention. The thermal conveyance depressions of the present invention are strategically positioned within the food preparation pan such that a high efficiency of thermal conveyance is achieved. The present invention also provides a unique opportunity to exploit culinary creativity as the depressions may be specially designed to provide a myriad of creative culinary pursuits. The preferred embodiment is typically made of a high durability material able to withstand varying degrees of temperature. Ranging from cooling, chilling and freezing techniques employed at commercial, residential or any such food preparation locations to the warming, heating and baking techniques used at the same locations. These locations may be restaurants, bakeries, households and food manufacturing facilities. Additional benefits to the present invention in addition to reduced cooking times, is a more even and flat top baking of food items. The present invention significantly and effectively increases the surface area of the pan while maintaining the relative size and shape of industry acceptable pans. When considering the increased surface area from each thermal conveyance depression, the conglomeration of thermal conveyance depressions substantially surpasses the surface area of prior art, and often approaches a nearly twice the total surface area. This increased surface area in baking applications enables a significantly faster heat transfer from ambient sources into or out of the foods and materials placed inside the pan. Because of a more rapid heat transference, food or materials, are baked more evenly with flatter top surfaces that significantly reduces boiling over and potential injury to persons removing pans from ovens and the such. As commonly understood in the baking trade, a flatter surface increases the ease with which the cake or confectionary treat may be iced.

The preferred embodiment also provides a more visually pleasing end product to the customer as a cake of the present invention may be decorated more beautifully, accurately with its relatively flat surface. The noticeable upward hump that occurs while baking cakes is due to the fact that the sides of the cake bake at a faster rate than at the center of the cake. The present invention greatly reduces this likelihood of producing a cake or any other such food product, casserole, breakfast bread, focaccia and so on, from having a hump in the middle. Other benefits to reduced baking time in the baking and freezing processes can include an increase in productivity and decrease in energy consumption. Saving even a few minutes of production time per item substantially adds up to a significant amount of time when calculated throughout a week, a month, a quarter or a fiscal year. An increase in productivity directly impacts what consumers pay for products. Also, because time is saved, energy use during the baking, cooking, steaming, freezing, chilling or cooling processes is substantially reduced. This likewise reduces greenhouse emissions.

In addition, the use of these thermal transference depressions may be uniquely configured to double as a novel cake pan, one which may have many commercial and residential applications. With a pan of the present invention utilizing the unique culinary depressions (UCD) the user pours the batter into the pan and similarly bakes a cake per the manufacturer's specifications, with the recommendation to reduce baking time. After baking, the cake is then easily inverted onto a receiving platform such as a plate, cardboard, plastic or metal board. With the cake inverted onto a stable platform, the thermal conveyance depressions are transformed into UCD suitable for filling. These UCDs may be filled with a variety of flavorful filling, such as cherry, apple, apricot, peach, lemon, Bavarian, chocolate, blueberry, lemon meringue, chocolate mousse, chocolate Bavarian, cream cheese, fig, pineapple, raspberry, strawberry, strawberry rhubarb, blackberry guava, date, banana crème, coconut or any other such filling can be imagined or created. Culinary creativity is then introduced into this process as multiple UCD may each be filled with a unique and distinct filling. This variety of fillings provides a plethora of choices and options by which to create new and flavorful combinations of cake and fillings never before made or produced. The cake or other such confectionary product may then be iced, frosted or dredged thereby adding an additional layer of flavoring to the already unique combination of cake and filling flavors. The thermal conveyance depressions may be applied on a wide variety of pan types and sizes for both commercial applications and residential applications. For example, Bundt pans, square, rectangle, circular, irregular shaped pans, pans shaped in the image of an American flag, angel food pans or any such suitable pan shape could be modified with varying sized and varied geometrically diversified UCDs.

Another benefit, in specific regards to the baking of cakes and other batter type products, that the introduction of these thermal conveyance depressions provides is the baking of a more traditional cake with a very smooth and flat top. Without the thermal conveyance depressions, a typical cake tends to bake irregularly. The edges and bottom of the cake bake at a significantly faster rate than does the center mass portion of the cake. Because the sides solidify and cook so quickly, the remaining liquid batter is forced into the center region of the pan. With extra batter being forced in toward the center, the center of the cake rises significantly higher than do the sides of the cake. The result is a cake with a noticeable hump in the center region of the cake.

When baking using two eight-inch round cakes, it is normal and expected to remove a majority of the hump on both cakes by making a nearly horizontal incision parallel to the base of the cake in order to ensure that when both halves are stacked one on top of the other that the appearance of the combined halves produces a flat and level surface with which to use as a base palette for icing and frosting. With the thermal conductive properties of the present invention with its thermal conveyance depressions and UCDs, the need to remove a top portion of any shaped cake is eliminated as the cake comes out in a nearly flat form. This flat topped form saves time and money as the person icing or frosting the cake need not take the extra time to remove and waste the unsightly hump, allowing more finished product to be presented to the consumer and in less time. The decorator then decorates the cake without risking the possibility of irrevocably damaging the cake due to an uneven cut while attempting to remove the hump.

Unlike the use of standard pans for creative food preparation, or by using a pan in a manner inconsistent with its intended reasons for manufacture, the present invention alleviates the wasted food, lost productivity, and personal injury. Attempting to manually alter the shape or intended purpose or design of a pan to attempt to accomplish the objectives of the present invention is beyond the skill of a person of average ability or a skilled baker for that matter. A pan with these unique thermal conveyance depressions or UCD overcomes the numerous problems associated with prior art.

The thermal conveyance depressions and UCD may vary in size, shape, and quantity depending upon the desired time savings, the heating and cooling effects, as well as how much energy is desired to conserve throughout the baking or cooking process. Their size, shape and quantity may be placed in any number of desired configurations to produce a wide variety of food preparation pans, and of course, resultant food items. As the application of the thermal conveyance depressions is of prime importance, the types of pans that this feature can be added to are wide in scope.

A unique aspect of the use of evenly spaced UCDs is the use of a complimentary planar surface with demarcations illustrating the location of points on a cake or food item outside the location of the UCDs. This combination provides for an easy system of cutting cakes, food items, casseroles, pies and the like, without accidentally puncturing one of the filled UCDs. In an application such as a supermarket, restaurant, or at a party the individual cutting the cake may efficaciously cut it in substantially equal segments, without accidental damage to the filling. This method of baking and subsequently serving the food item in essentially equal portions provide an excellent means of portion control. As is commonly known in the supermarket and the restaurant trade, portion control is one of the most important aspects of making and selling food items.

The depressions may be manufactured with pans made from aluminum foil, steel, aluminum, plastic, iron, ceramic, silicone and, glass or any other such material that is commonly used in the preparation, heating and cooling of food and food items. The preferred materials to manufacture pans with the unique depressions and UCDs of the present invention are aluminum foil of varying thicknesses, aluminum sheeting formed into pans, steel sheeting that is formed into pans and plastic pans that may be formed by injection molding and thermoforming techniques. In specific regards to baking cakes, a silicone pan with thermal conveyance depressions in the form of UCDs may prove an ideal cake baking material that enables a smooth and clean removal, transference upon inversion of the cake from the silicone pan onto a substantially solid base.

The embodiments the present invention can provide:
1) A more effective means of thermal conveyance through one or more depressions;
2) A greatly reduced cooking, baking, chilling or freezing time of food items;
3) A baking pan and system that improves productivity.
4) A baking pan that improves the shelf life of manufactured food items.
5) A reduction in energy consumption by heating or cooling at reduced temperatures
6) A food pan with a means to prepare foods in a more creative manner;
7) A means of manufacturing a food preparation pan;
8) A method of using a food preparation pan;
9) A method of removing food from the pan;
10) A method of satisfying the filling depressions;
11) A method or frosting, icing, coating or layering materials, decorates and other artistic embodiments onto the prepared foods;
12) A method of cutting removed food items from the food preparation pan;
13) A method of evenly cutting and serving food items from a serving surface.
14) A method of providing portion control to food items.
15) A food item that has been filled, which filling remains intact after being cut into individual portion.
16) A cake that has been filled, which filling remains intact after being cut into individual portion of cake.
17) An individual food item that has been cut and separated from an original, parent food item, which food item contains a filling that remains intact.
18) An individual food item that has been cut by using demarcation lines.
19) An individual food item that has been cut by using demarcation notches.

Furthermore, the description herein of the preferred embodiments broadly states the methodologies that may be used in order reduce cooking and freezing time, reduce required cooking and freezing temperatures, produce level food items, improve extraction of baked goods from the pan, satisfy the filling depressions, coat, layer, ice or apply frosting to the goods removed from the pan and accurately cut the food items or cake items without disturbing said filling depressions. The design greatly increases the surface area of the bottom of the pan that is exposed to ambient temperatures. Surface area increases can easily double the original surface area of the pan. Due to the large increase in exposed surface area, thermal energy transfer (cooking or cooling and freezing) into and out of the food happens at a greatly increase rate. In other words, food cooks faster and cools/freezes faster using this pan. Energy (oven temperature or cooling/freezing temperature) required to properly cook or cool/freeze foods is reduced due to the large increase in surface area exposed to ambient temperature of the pan. Time required to properly cook or thoroughly cool/freeze food is reduced due to the large increase in surface area exposed to ambient temperature of the pan. Food items such as liquid batters, bake flatter than traditional pans. The high thermal transfer rate, due to the increased surface area, causes the center area of the liquid batters to bake at a rate nearly equal to the sides. This rapid thermal transfer and reduced energy and time required for baking produces a flatter cooked product. The variable geometry also creates a uniquely identifiable way to control portions of food items placed in the pan.

### BRIEF DESCRIPTION OF THE DRAWINGS

FIG. 1 is a top perspective view of the present invention illustrating the components that make up the preferred embodiments and their related elements.

FIG. 2 is a bottom perspective view of the pan in FIG. 1.

FIG. 3 is a top perspective view of the present invention with variation on the thermal conveyance depressions.

FIG. 4 is a top perspective view showing the present invention filled with a batter.

FIG. 5 is a top perspective view of another variation of the present invention.

FIG. 6 is a bottom perspective view of the invention in FIG. 5.

FIG. 7 is a top perspective view of cake manufactured with a pan of the present invention, whereas the cake has been inverted, placed on a planar surface and is ready to be iced.

### DETAILED DESCRIPTION OF THE INVENTION

### A. Description of the Present Invention

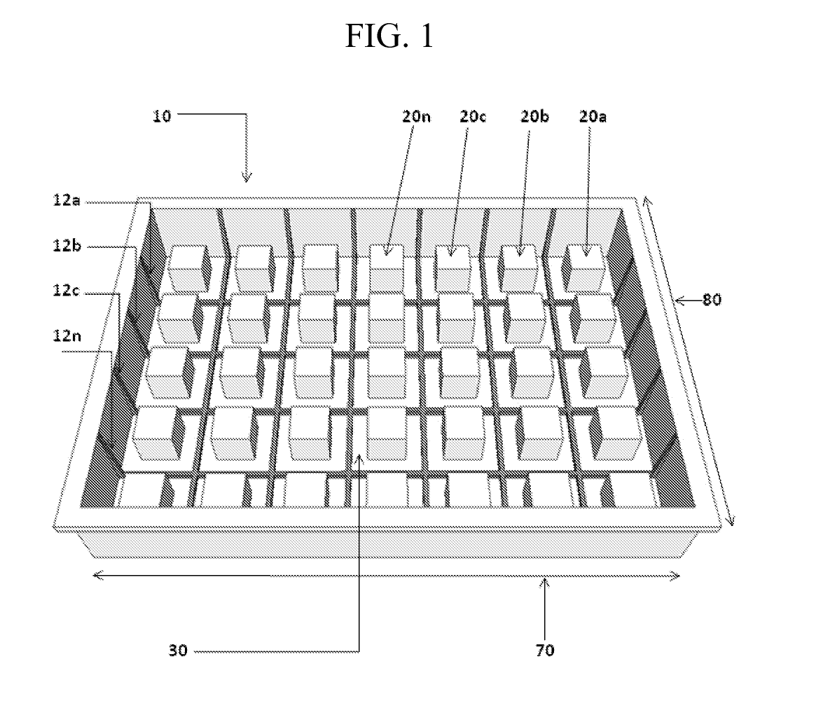

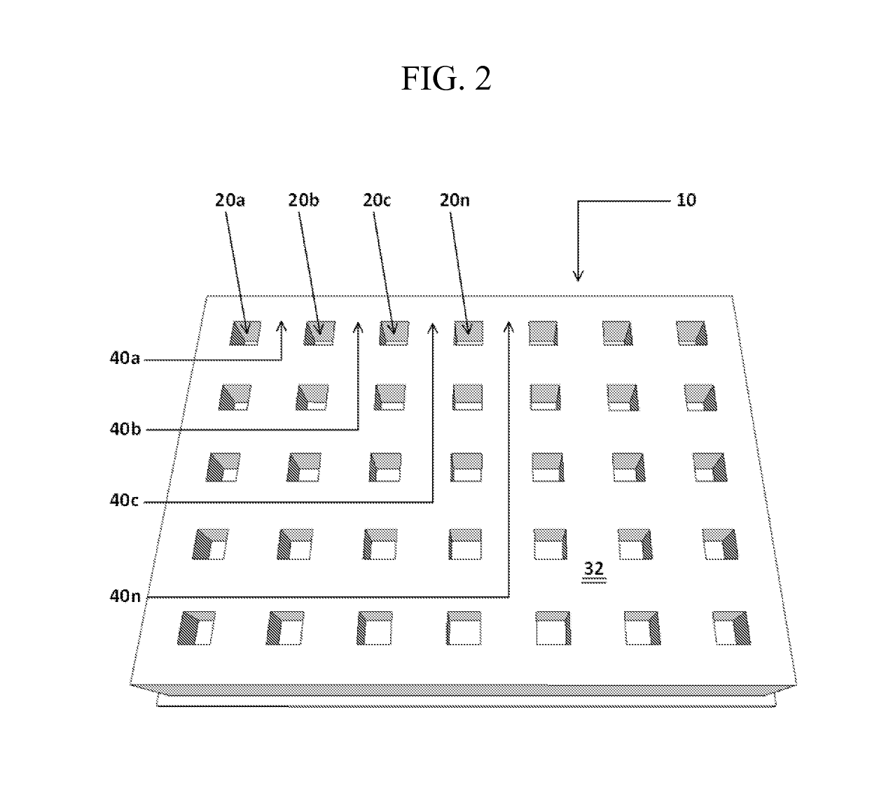

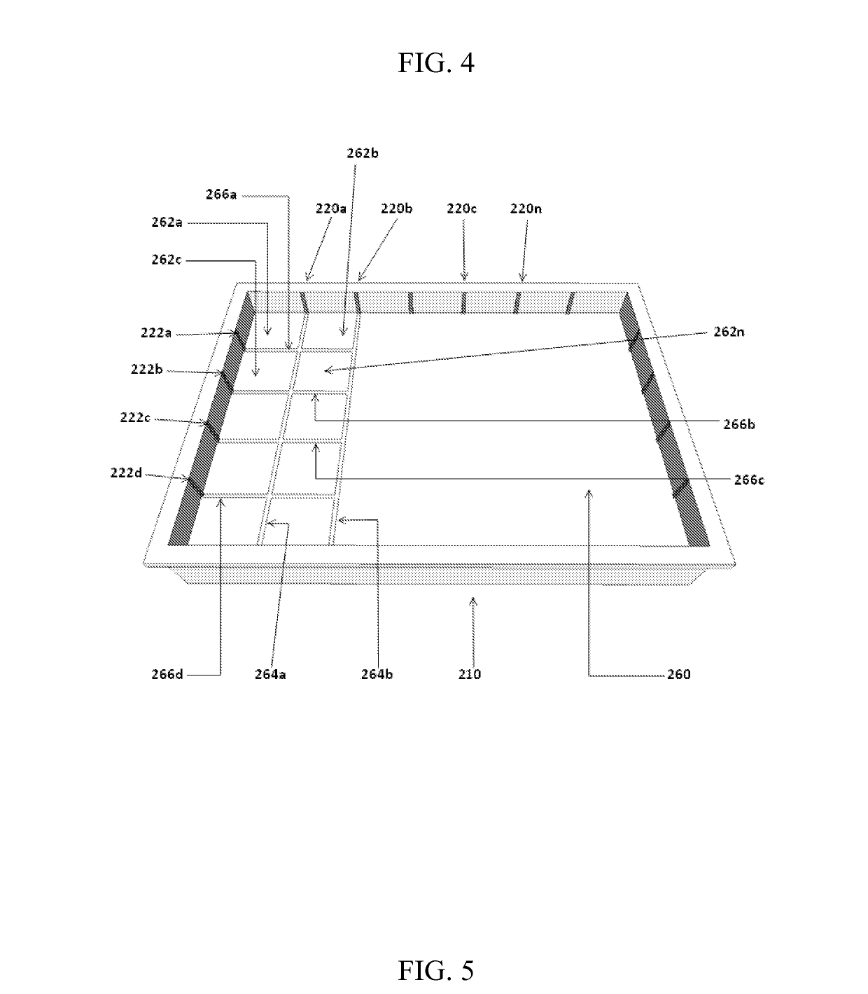

In FIGS. 1 and 2, the present invention, pan 10 consists of a plurality of thermal conveyance depressions 20a, 20b, 20c, and 20n protruding in a vertically oriented disposition relative to a typically horizontal inner pan bottom surface 30. As illustrated in FIG. 2 the plurality of thermal conveyance depressions 20a, 20b, 20c, and 20n are upwardly projected depressions in outer pan bottom surface 32, which depressions are essentially hollow as they are spaced in between by bridging portions 40a, 40b, 40c, and 40n. In FIG. 1 demarcation lines 12a, 12b, 12c, and 12n may be used to evenly cut the food item contained within as illustrated in FIG. 4. In such a manner, the even cutting of food items provides excellent portion control for restaurants, supermarkets, caterers and so on.

The thermal conveyance depressions 20a, 20b, 20c, and 20n are formed into the pan provide substantially greater heat transference into a food item contained within pan 10. It is easy to understand that the increased surface area that is heated, or cooled as the case may be, with the present invention provides substantially greater thermal transfer (hot or cold) than tradition baking and chilling pans. The thermal conveyance depressions of the present invention are best made in a hollow disposition as opposed to solid disposition, as solid upwardly protruding projections would substantially lose thermal transfer effectiveness from ambient temperatures into or out of a food item in a pan.

Thermal conveyance depressions 20a, 20b, 20c, and 20n are typically evenly spaced apart with bridging portions 40a, 40b, 40c, and 40n. The final shape and sizes of depressions 20a, 20b, 20c, and 20n are relative to the size of the desired pan and may be as few as one, or as many as 12, 24, or perhaps many more. The amount is generally determined by the numbers of portions that will be cut from the food item, thus the present invention provides excellent portion control. As an example, if a nine by thirteen inch pan were manufactured, it would contain more thermal conveyance depressions, and would most likely be of greater size than those on an eight by eight inch square pan. Though the height and shape of a pan of the present invention may vary, the typical overall height of the depressions would not exceed the maximum height of the pan.

As illustrated in FIG. 2, the depressions 20a, 20b, 20c, and 20n are as devoid of any extra and unnecessary construction material as is possible given their relative size and shape to the overall size and shape of the pan 10. FIG. 2 clearly illustrates the substantial increase in surface area by the addition of depressions 20a, 20b, 20c, and 20n. Thus a high degree of thermal transfer both into and out of the pan 10 thereby reduces cooking and freezing times as well as consuming less energy.

As illustrated in FIGS. 1 and 2, the length 70 and width 80 of pan 10 is sufficient to produce thirty five relatively evenly spaced thermal conveyance depressions 20. In this particular configuration, when adding the surface area of pan 10 and the additional surface area created by the plurality of depressions 20a, 20b, 20c, and 20n, the thermal conveyance surface area of pan 10 nearly doubles that of a traditional prior art pan. Assuming that pan 10 in FIG. 1 is 14″×10″, and factoring in the thirty five depressions 20a, 20b, 20c, and 20n, the estimated additional bottom surface area is about one hundred and forty square inches of square surface area. Thus it totals nearly two hundred and eighty square inches of surface area exposed to heat transference, double that of a traditional prior art pan of the same size.

### B. Variation of the Present Invention

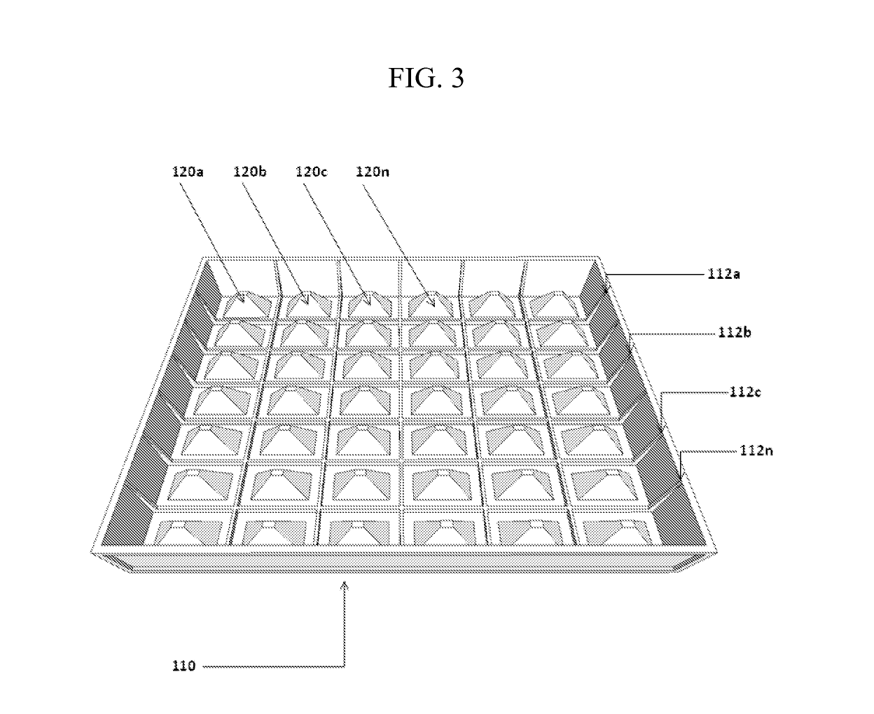

In FIG. 3, the present invention, pan 110 consists of a plurality of thermal conveyance depressions 120a, 120b, 120c, and 120n protruding in a vertically oriented disposition relative to a typically horizontal inner pan bottom surface 130. Pan 110 is more or less square, with depressions 120a, 120b, 120c, and 120n being reminiscent of a pyramid shape. This pyramidal shape may be rectangular, square, even three side, or perhaps a multitude of other shapes. As illustrated the plurality of thermal conveyance depressions 120a, 120b, 120c, and 120n are upwardly projected depressions much like those in FIGS. 1 and 2 and are essentially hollow with bridging portions in between, again, essentially the same or similar to those in FIGS. 1 and 2. In FIG. 3 demarcation lines 112a, 112b, 112c, and 112n may be used to evenly cut the food item contained within as illustrated in FIG. 4. Likewise, the even cutting of food items provides an excellent portion control system for restaurants, supermarkets, caterers and so on.

In FIG. 3, pan 110 illustrates a potential shape, size and configuration of an depression that may be easier to manufacture than the invention in FIGS. 1 and 2. The reason is that production as an aluminum foil, steel, or even plastic product would provide for faster, easier mold release. Depressions of the 120 variety would be conducive to baking cakes. The greater angle of the sloped depressions 20 would enable an easier release of a cake when inverting onto a solid base. Certain limitation to the final shape and size could be limited to the type of material used to create the final shape and form of the pan. As an example for clarification purposes, a more square structure could easily be incorporated into a pan comprised of a high heat silicone but, may lose manufacturability properties when considering a thermoformed plastic pan or a stamped metal pan.

### C. Method of Use

In FIG. 4, pan 210 is much like that of the pans in FIGS. 1, 2, and 3 and has six evenly spaced demarcations lines 220a, 220b, 220c, and 220n, in a first direction with four evenly spaced demarcations lines 222a, 222b, 222c, and 222d, in a second direction, which direction is more or less perpendicular the first direction. Contained within pan 210 is an already cooked (or prepared) food item 260, which completely covers the underlying thermal conveyance depressions (not shown). As illustrated food item 260 has been cut into ten portion controlled pieces 262a, 262b, 262c, and 262n. This has been accomplished by a user making cuts 264a and 264b across demarcations lines 220a and 220b in their first direction and then making cuts 266a, 266b, 266c and 266d across demarcations lines 222a, 222b, 222c, and 222d in the second direction. As goes without saying cutting a food item in the present invention is done by cutting across the food item beginning at one demarcation line across the food item to the corresponding demarcation line on the opposing side of the pan.

This food item 262 in FIG. 4 may be a cake, a previously frozen casserole dish that has been prepared by a food manufacturer or a caterer or in a supermarket or restaurant and intended for consumer usage. It could also represent a pan that has been filled with a cake batter and is ready to be placed into an oven for final baking should the cut lines not be illustrated. It is obvious to anyone skilled in the art of baking, cooking and preparing foods of this sort to understand be process of “pouring in a batter” or preparing a casserole, or perhaps making lasagna and so on. Regardless of the food that has been prepared, the thermal conveyance depressions, the food item is heated and baked in less time than a prior art pan or the standard manufacturer's directions would otherwise indicate. The preparer may use a lower temperature thereby saving or consuming less energy, or may cook the food item in a shorter time frame.

D. A variation of the Present Invention

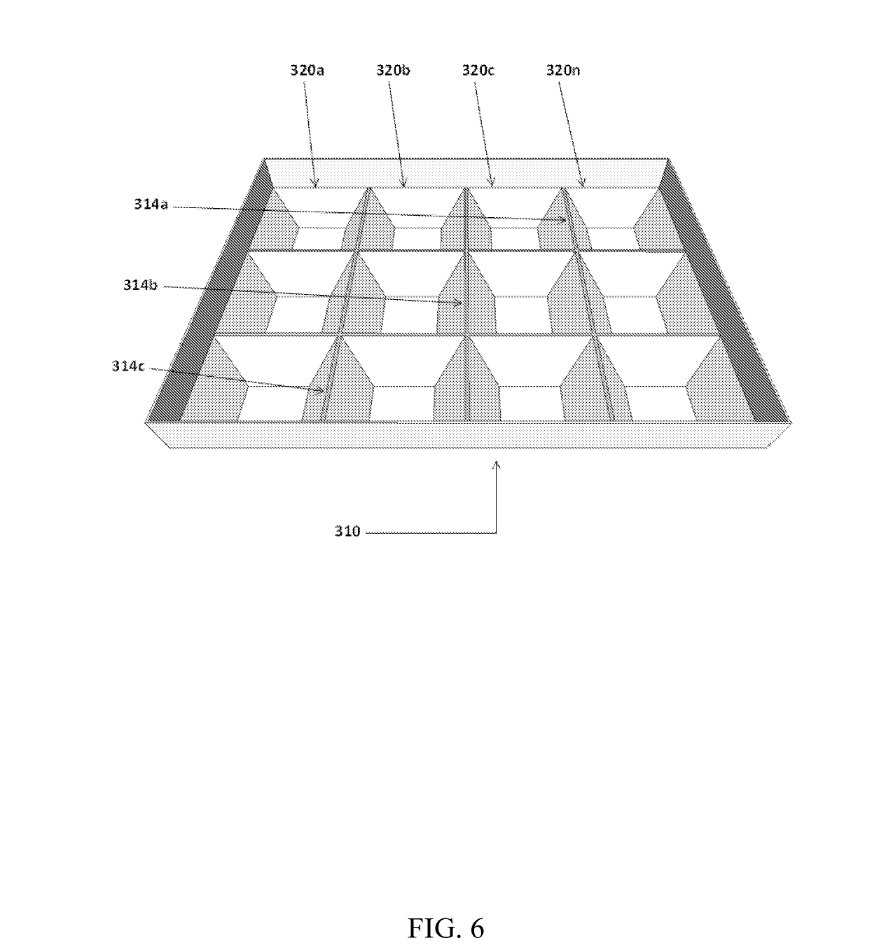

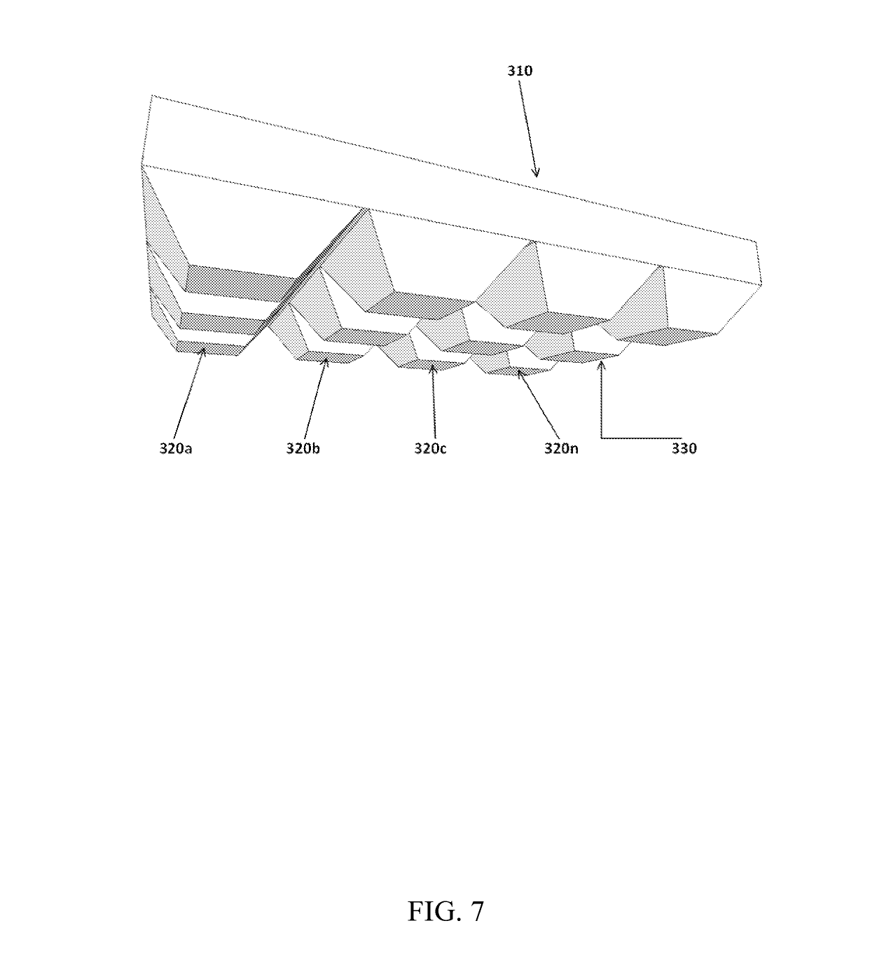

In FIGS. 5 and 6, the variation of the present invention, pan 310 consists of a plurality of thermal conveyance depressions 320a, 320b, 320c, and 320n protruding downward in a vertically oriented disposition, opposite that of the preferred embodiment of the inventions in FIGS. 1, 2, and 3. Pan 310 is more or less a mirror image of those in FIGS. 1, 2 and 3, as the previous inventions has upwardly protruding depressions which are more or less isolated from each other and spaced apart. With pan 310 the thermal conveyance depressions 320a, 320b, 320c, and 320n are congruent and linked along lines 314a, 314b, and 314c. This configuration serves two purposes. First it dramatically increases the surface area of the pan bottom 330, which allows for significantly reduces cooking and freezing times of food items. It also accomplishes the cooking and freezing cycles, or thermal conveyance, using less energy than previously required. The second purpose the configuration of the present invention 310 is to it provides excellent portion control to retailers, caterers, and so on. For example, a food manufacturer may link the depressions to provide the portion control desired by the retailers, caterers, restaurants, and so on. If the manufacturer determines that resellers prefer a four ounce portion of a particular product is an appropriate serving size, the linked depressions may be sized accordingly. An infinite number of possibilities in size and shape may accommodate a reseller's preference.

### E. A Second and Third Invention and Related Methods and Process

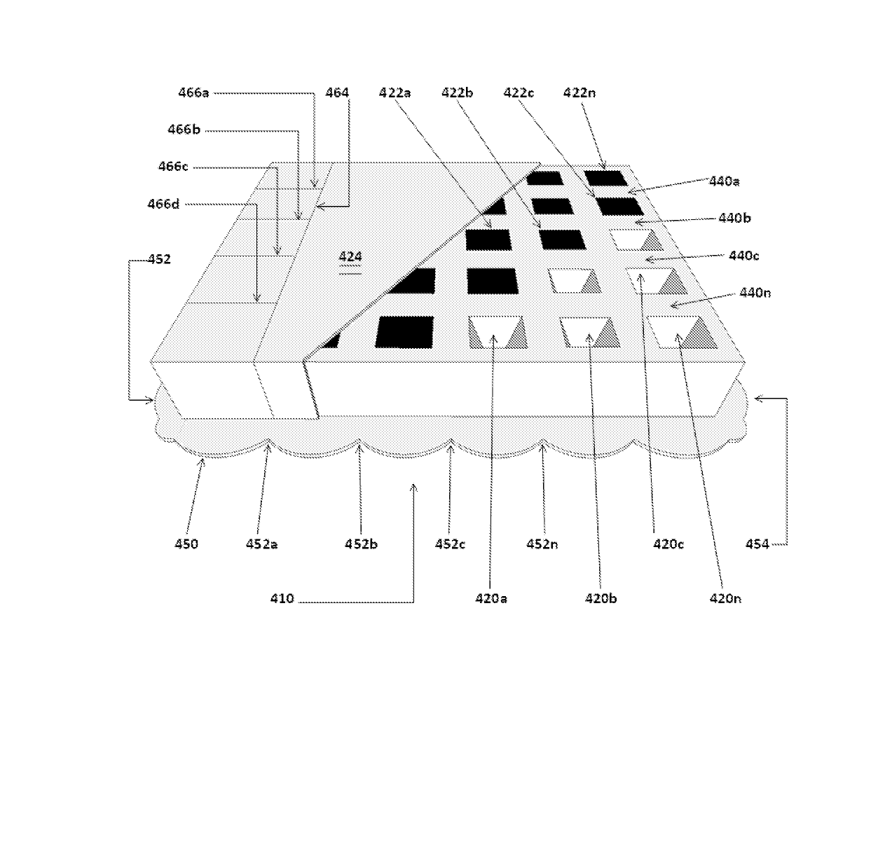

In FIG. 7 present invention sheet cake 410 is an inverted version of the type that may be made by using the present invention pan much like pan 10 in FIGS. 1 and 2. Cake 410 has a plurality of filling depressions 420a, 420b, 420c, and 420n protruding downward into cake 410 in a vertically oriented disposition. These filling depressions 420a, 420b, 420c, and 420n are made by a plurality of corresponding thermal conveyance depressions much like those in FIG. 1, which depressions are numbered 20a, 20b, 20c, and 20n. These types of upwardly projected thermal conveyance depressions create the essentially hollow filling depressions 420a, 420b, 420c, and 420n, which are spaced in between with bridging portions 440a, 440b, 440c, and 440n. As illustrated, cake 410 sits upon a flat serving surface 450, which serving surface contains demarcation notches 452a, 452b, 452c, and 452n that may be used to evenly cut cake 410 in a manner much like that illustrated in FIG. 4. In such a manner, the even cutting of cake 410, or any food item for that matter, provides excellent portion control for restaurants, supermarkets, caterers and so on.

What makes present invention cake 410 so unique is that filling depressions 420a, 420b, 420c, and 420n, may be filled with various types of fillings as illustrated by the darkened filled in depressions 422a, 422b, 422c, and 422n. Once the filling depressions are filled with filling, the cake is then iced with icing 424. Icing a cake of the present invention is substantially improved in that the top surface of a cake cooked with a pan of the present invention provides a unique, perfectly level surface. There is no humping, or rounding in the middle. This makes it easy to fill, easy to ice and does not interfere with cutting.

As illustrated cut lines 464 is in a first direction and cut lines 466a, 466b, 466c and 466d are in a second direction and are perfectly spaced equidistant between the filling depressions. Cut 464 connects from the demarcation notches 452a across to its corresponding demarcation notch on the opposing edge, and cuts 466a, 466b, 466c and 466d correspond between its demarcation notches, which run along sides 452 and 454 (not shown) on flat serving surface 450. As illustrated these demarcation notches are used in much the same manner to line up and guide cuts in a food item much like those of the demarcation lines of the 264 and 266 variety illustrated in FIG. 4. These cut lines 464, 466a, and 466b create portion control pieces of cake without disturbing the filling inside. Thus, the portion control system of the present invention also serves the purpose of providing a single piece of cake to a consumer that will literally burst with delicious filling when cut with a fork and eaten.

It goes without saying that the cutting a cake or food item as illustrated in FIG. 7 is done by cutting across the food item beginning at one demarcation notch across the food item to the corresponding demarcation notch on the opposing side of the serving surface. Filling depressions may be filled with an infinite variety of fillings, such as cherry, apple, apricot, peach, lemon, Bavarian, chocolate, blueberry, lemon meringue, chocolate mousse, chocolate Bavarian, cream cheese, fig, pineapple, raspberry, strawberry, strawberry rhubarb, blackberry guava, date, banana crème and, coconut and so on. Typically a cake or food item would be iced, frosted or otherwise more or less in a traditional manner, but may not be iced if preferred. For example, delicious apple filled breakfast cobblers may be best suited to remain with any form of icing.

Yet another most interesting outcome of using the present invention as previously described herein is that it may be used for make standards cake sheets, round or flat and are not filled. The benefit of using the present invention as described herein, provides a flat surface, which is highly desirable for layer cakes. The use of a pan such as that illustrated in FIG. 3 is that it not only improves cooking efficiencies but once the cake is extracted and not invented, the hollowed out sections are on the base and more or less covered up. Thus the top of the cake is perfectly level and may be layered or effectively iced in this perfectly level disposition. For professional bakers and cake builders, the present invention eliminates any sculpting of a hump or rounded, uneven center of a layer. Each layer is level, consistent and easy to layer and frost.

### F. Method of Manufacture

All of the preferred embodiment of the inventions disclosed herein and the multitude of variations may be made in any suitable shape and size. Examples of suitable shapes could be round, oval, square, rectangular, triangular, shape of the states of the United States, Bundt shape, angel food cake pan shape, holiday wreath, heart shaped or any other such suitable shape. Suitable sizing may be for extra large portions, even as large as 8″×8″ or small enough for bite size portions. The concepts of the filling/thermal conveyance depressions can be applied to any shaped pan. As disclosed herein the types of cakes and foodstuffs that fall under the scope of the present invention are essentially unlimited, only that they either have a filling a flat surface or are cut with some form or portion control as described herein.

The pan of the present invention illustrate only a few examples of what is possible. The spirit of the present invention provides a breadth of scope that includes all methods of making and using it. Any variation on the theme and methodology of accomplishing the same that are not described herein would be considered under the scope of the present invention. In this particular configuration of pan and thermal conveyance depressions, this particular design is meant for a creative cake pan.

What is claimed is:

1. A method for cooking with a pan, comprising
forming a plurality of thermal conveyance depressions protruding in a vertically oriented disposition relative to a horizontal inner pan bottom surface; and
forming upwardly projected depressions in an outer pan bottom surface of the thermal conveyance depressions to form hollow depressions spaced in between by bridging portions.

2. The method of claim 1, comprising increasing a bottom surface area of the pan that is exposed to ambient temperatures.

3. The method of claim 2, wherein the surface area can increase up to twice the original surface area of the pan.

4. The method of claim 1, comprising increasing thermal energy transfer (cooking, cooling or freezing) into and out of the food.

5. The method of claim 1, comprising reducing energy required to cook, cool or freeze foods due to an increase in surface area exposed to ambient temperature of the pan.

6. The method of claim 1, comprising decreasing time required to cook, cool or freeze food due to an increase in surface area exposed to ambient temperature of the pan.

7. The method of claim 1, comprising baking liquid batters to provide flat surfaces.

8. The method of claim 7, comprising providing a predetermined thermal transfer rate, due to an increased surface area, to cause a center area of the liquid batters to bake at a rate nearly equal to the sides.

9. The method of claim 1, comprising producing a flat cooked product using a rapid thermal transfer and reduced energy and time.

10. The method of claim 1, comprising providing variable geometry depressions to control portions of food items placed in the pan.

11. A pan, comprising:
a plurality of thermal conveyance depressions protruding in a vertically oriented disposition relative to a horizontal inner pan bottom surface, and
upwardly projected depressions in an outer pan bottom surface of the thermal conveyance depressions to form hollow depressions spaced in between by bridging portions.

12. The pan of claim 11, wherein the depressions increase a surface area of the bottom of the pan that is exposed to ambient temperatures.

13. The pan of claim 12, wherein the increased surface area can reach twice the original surface area of the pan.

14. The pan of claim 11, wherein the depressions increase exposed surface area to increase thermal energy transfer into and out of food.

15. The pan of claim 14, wherein the thermal energy comprises cooking, cooling or freezing of food.

16. The pan of claim 11, wherein the depressions reduce energy required to prepare food.

17. The pan of claim 11, wherein the depressions increase surface area exposed to ambient temperature of the pan to reduce energy required to cook, cool or freeze foods.

18. The pan of claim 11, wherein an increase in surface area exposed to ambient temperature of the pan decreases time required to cook, cool or freeze food.

19. The pan of claim 11, wherein an increase in surface area provides a predetermined thermal transfer rate to cause a center area of the liquid batters to bake at a rate nearly equal to the sides.

20. The pan of claim 11, comprising variable geometry depressions to control portions of food items placed in the pan.
